(19) United States
(12) Patent Application Publication
(10) Pub. No.: US 2003/0124051 A1
(43) Pub. Date: Jul. 3, 2003

(54) Indium-tin oxides

(76) Inventors: Sabine Servaty, Grosslittgen (DE); Gunther Michael, Karlstein (DE); Christiane Heyer, Erkrath (DE); Stipan Katusic, Kelkheim (DE); Horst Miess, Kahl (DE); Peter Kress, Freigericht (DE)

Correspondence Address: SMITH, GAMBRELL & RUSSELL, LLP, 1850 M STREET, N.W., SUITE 800, WASHINGTON, DC, 20036, US

(21) Appl. No.: 10/175,142

(22) Filed: Jun. 20, 2002

(30) Foreign Application Priority Data
Jun. 20, 2001 (DE) 101 29 376.3

(51) Int. Cl. C01G 15/00; C04B 14/00

(52) U.S. Cl. 423/593; 106/401

(57) ABSTRACT

Indium-tin oxides with the following physical and chemical properties:

| | |
|---|---|
| Mean primary particle size | 1 to 200 |
| obtained from TEM | |
| BET surface (DIN 66131) | 0.1 to 300 m²/g |
| Structure XRD | cubic indium oxide |
| | tetragonal tin oxide |
| Mesopores according to the | 0.03 mL/g to 0.30 mL/g |
| BJH method (DIN 66134) | |
| Macropores (DIN 66133) | 1.5 to 5.0 mL/g |
| Bulk density (DIN ISO 787/XI | 50 to 2000 g/L |

are produced by mixing a solution of an indium salt with a solution of a tin salt, by atomizing this mixture of solutions, and by pyrolyzing the atomized mixture of solutions. These indium-tin oxides are used for the production of transparent electrically conducting paints and coatings.

### INTRODUCTION AND BACKGROUND

The present invention relates to indium-tin oxides, a method for their production and their use.

Indium-tin oxides are used in electrically conductive surface coatings, for example, glass panes.

It is known that indium-tin oxides can be applied to glass panes by immersing the glass panes in a solution of a hydrolyzable compound of indium and tin, by drying them, and by subsequently calcining them at a temperature up to 550° C. (U.S. Pat. No. 4,568,578). The known method has the disadvantage that the method cannot be used to coat, e.g., plastic materials.

Therefore, an object of the present invention is to coat plastic materials with indium-tin oxides.

### SUMMARY OF THE INVENTION

The above and other objects of the invention can be achieved by an indium-tin oxide that is characterized by the following physical and chemical properties:

| | |
|---|---|
| Mean primary particle size | 1 to 200 |
| obtained from TEM | |
| BET surface (DIN 66131) | 0.1 to 300 m²/g |
| Structure XRD | cubic indium oxide |
| | tetragonal tin oxide |
| Mesopores according to the | 0.03 mL/g to 0.30 mL/g |
| BJH method (DIN 66134) | |
| Macropores (DIN 66133) | 1.5 to 5.0 mL/g |
| Bulk density (DIN ISO 787/XI) | 50 to 2000 g/L |

The indium-tin oxide according to the present invention can be doped with the following materials in the form of the oxides and/or the elemental metals:

| | |
|---|---|
| Aluminum | Yttrium |
| Magnesium | Tungsten |
| Silicon | Vanadium |
| Gold | Manganese |
| Cobalt | Iron |
| Copper | Silver |
| Palladium | Ruthenium |
| Nickel | Rhodium |
| Cadmium | Platinum |
| Antimony | Osmium |
| Cerium | Iridium |
| Zirconium | Calcium |
| Titanium | Zinc |

with the possibility of using the corresponding salts as the starting material

### DETAILED DESCRIPTION OF INVENTION

Another feature of the present invention is a method for the production of the indium-tin oxide according to the present invention which is characterized by the fact that a solution of an indium salt is mixed with a solution of a tin salt, that optionally a solution of at least one doping component is added, that this mixture of solutions is nebulized, that the nebulized mixture of solutions is pyrolyzed, and that the product obtained is separated from the waste gases.

As salts, inorganic compounds, such as chlorides or nitrates, and organometallic precursors, such as acetates or alcoholates, can be used.

In addition, the mixture of solutions can also contain a dispersion of a pyrogenically produced silicic acid which can optionally be hydrophobed or a silica sol. In this context, it should be remembered that silicic acid functions as a nucleus, which means that as a result, the maximum particle size of the silicic acid is determined by the maximum particle size of the final product.

The solution can optionally contain water, water-soluble organic solvents, such as alcohols, for example, ethanol, propanol and/or acetone.

The nebulization of the solution can be carried out using an ultrasound nebulizer, an ultrasound atomizer, a two-fluid nozzle, or a three-fluid nozzle.

If an ultrasound nebulizer or an ultrasound atomizer is used, the aerosol obtained can be mixed with the carrier gas and/or N₂/O₂ air which is supplied to the flame.

If a two-fluid nozzle or a three-fluid nozzle is used, the aerosol can be sprayed directly into the flame.

It is also possible to use organic solvents that are not miscible with water, such as ether.

The separation can be carried out by means of a filter or a cyclone.

The pyrolysis can be carried out in a flame produced by burning hydrogen/air and oxygen. Instead of hydrogen, it is possible to use methane, butane, or propane.

The pyrolysis can also be carried out by means of a furnace that is heated from the outside.

It is also possible to use a fluidized bed reactor, a rotary tube or a pulsing reactor.

The indium-tin oxide according to the present invention can be used to produce transparent and electrically conductive paints and coatings; the coatings may have a sticky surface (adhesive). Other applications for the indium-tin oxide are flat displays, Smart Windows or solar cells.

It has the following advantages:

Depending on the doping element used, the product has a specific color and a specific use.

It has a maximum particle size of 300 nm to ensure good transparency.

### EXAMPLES

The process parameters for the production of the indium-tin oxides according to the present invention are listed in the following table:

| | Production | | |
|---|---|---|---|
| | Test No. | PH04408 | PH04410 |
| Metal | Composition | In/Sn/Mg/Al | In/Sn/Au |
| | Type | All chlorides | All chlorides |
| | wt % | 93/5/0.3/1.7 | 94/5.5/0.5 |
| Solution | Throughput, g/h | 560 | 570 |
| | Dissolved in | H2O | H2O |
| | Concentration, % | 3 | 3 |
| Nebulization | Ultrasound | x | |
| Nozzle | Two-fluid nozzle | | x |
| Quantity of gas, | H2 | 1.2 | 1.2 |
| m³/h | N2/O2 | 0/0.3 | 0/0.2 |
| | Atomized | 1.5 | 1.5 |
| | Secondary | | 1.5 |
| | Primary | 3 | 1.6 |
| | Lambda | 2.24 | 1.93 |
| Reactor | T 1 | 751 | 781 |
| temperature, ° C. | T 2 | 720 | 765 |
| | T 3 | 721 | 749 |
| | Filter | 241 | 240 |

The physical and chemical parameters of the products obtained are listed in the following tables:

Material data, ITO analysis

| | | Test No. | | | |
|---|---|---|---|---|---|
| | | PH04408 | PH04410 | PH04411 | PH04412 |
| Phase analysis - XRD | | Cubic In2O3 | Cubic In2O3 | Cubic In2O3 | Cubic In2O3 |
| Grain size from | BET [nm] | 31 | 17 | 15 | 15 |
| | XRD [nm] | 32 | 20 | 19 | 19 |
| Distribution from TEM | | Homogeneous distribution | | | |
| | | with spheres | | | |
| Particle diameter | DN [nm] | 21.04 | | | |
| Specific surface | OEM | 26.319 | | | |
| | [m2/g] | | | | |
| Mean number | D50 (A) | 17.516 | | | |
| distribution | [nm] | | | | |
| Mean weight | D50 (g) | 32.701 | | | |
| distribution | [nm] | | | | |
| 90% Sp. number | nm | 9.87-36.65 | | | |
| distribution | | | | | |
| 90% Sp. weight | nm | 14.67-87.66 | | | |
| distribution | | | | | |
| Total range | nm | 7.40-116.6 | | | |
| Specific surface | (m²/g) | 26 | 49 | 54 | 55 |
| BET | | | | | |
| Micropores (t-plot according to | | None | None | None | None |
| de Boer) | | | | | |
| Metal | Composition | In/Sn/Mg/Al | In/Sn/Au | In/Sn/Au | In/Sn/Au |
| | wt % | 93/5/0.3/1.7 | 94/5.5/0.5 | 90/8/1 | 90/7/3 |
| RFA | % | 89/5.1/0.5/3.2 | 90.9/7.6 | 89/9 | 88.7/8.75 |
| Specific | | | | | |
| resistance (ohm) | | | | | |
| Compression | at 0.5 | 1.00E+03 | 1.00E+04 | 1.00E+04 | 1.00+05 |
| density | g/cm³) | | | | |
| Surface analysis | Metal | In/Sn/Au | | | |
| (XPS) | | | | | |
| | Atom % | 25/0.96/0.25 | | | |
| | In/Sn | 26.04 | | | |
| C content, ppm | | 1000 | | | |
| Cilas d = 50 in | Without | | | | |
| mμm | ultrasound | | | | |
| | With | 1.56 | 1.2 | | 1.1 |
| | ultrasound, | | | | |
| | 120 sec | | | | |
| L/a/b values | | 85.48/2.28/22.08 | 76.15/1.88/20.01 | 66.31/4.72/11.16 | 52.2/7.16/0.2 |
| Color | | Yellowish green | Yellow | Yellow | Purple |
| | | | Green | Green | |
| | | | Orange | Pink | |
| Density g/L | | | 150 | 280 | 253 |

The products according to the present invention contain a cubic indium oxide and a tetragonal tin oxide.

Further variations and modifications of the invention will be apparent to those skilled in the art from the foregoing and are intended to be encompassed by the claims appended hereto.

German priority application of Jun. 20, 2001 is relied on and incorporated herein by reference.

We claim:

1. Indium-tin oxide, having the following physical and chemical parameters:

| | |
|---|---|
| Mean primary particle size | 1 to 200 |
| obtained from TEM | |
| BET surface (DIN 66131) | 0.1 to 300 m²/g |
| Structure XRD | cubic indium oxide |
| | tetragonal tin oxide |
| Mesopores according to the | 0.03 mL/g to 0.30 mL/g |
| BJH method (DIN 66134) | |
| Macropores (DIN 66133) | 1.5 to 5.0 mL/g |
| Bulk density (DIN ISO 787/XI) | 50 to 2000 g/L |

2. A method for the production of the indium-tin oxide according to claim 1 comprising mixing a solution of an indium salt with a solution of a tin salt, optionally adding a solution of a salt of at least one doping component to obtain a mixture of solutions, nebulizing this mixture of solutions, pyrolyzing the resulting nebulized mixture of solutions, and separating the product obtained from the waste gases.

3. An article coated with the indium-tin oxide as claimed in claim 1.

4. A plastic pane coated with the indium tin oxide of claim 1.

5. The method according to claim 2 wherein the indium salt is an inorganic salt.

6. The method according to claim 2 wherein the tin salt is an inorganic salt.

7. An electrically conductive and transparent paint containing the indium tin oxide of claim 1.
